(19) United States
(12) Patent Application Publication
(10) Pub. No.: US 2005/0057830 A1
(43) Pub. Date: Mar. 17, 2005

(54) Laminated color light filter

(75) Inventors: Joseph W. Coburn JR., Jackson, NJ (US); Robert C. Weiss, Jackson, NJ (US)

Correspondence Address: R. GALE RHODES, JR., OF COUNSEL;MOSER, PATTERSON & SHERIDAN, LLP, Suite 100, 595 Shrewsbury Avenue, Shrewsbury, NJ, 07702, US

(73) Assignee: Creative Film Corp.

(21) Appl. No.: 10/664,027

(22) Filed: Sep. 13, 2003

(51) Int. Cl. G02B 5/22

(52) U.S. Cl. 359/885; 359/892

(57) ABSTRACT

A laminated color dye filter including a layer of substantially transparent dye-colored plastic laminated to a layer of substantially transparent base material such as glass. The thermal conductivity of the base material is greater than the thermal conductivity of the plastic. Upon the plastic becoming heated as light passes therethrough a portion of the heat is transferred to the base material which dissipates or conveys away at least a portion of the heat thereby providing the laminated color light filter with an increased useful life. An article of manufacture including a layer of substantially transparent dye-colored plastic having a layer of substantially transparent pressure-sensitive adhesive applied to one surface thereof and which may include a release liner or sheet covering the layer of adhesive.

### BACKGROUND OF THE INVENTION

This invention relates generally to color light filters and more particularly relates to a laminated color light filter.

Color light filters are known to the art for providing a single color of light, upon white light comprising of a plurality of colors of light in the visible light spectrum, being transmitted therethrough. As is further known to the art, the color of light provided by color light filters is dependent upon the color of the light filter and the color of the filter is dependent on the color of the dye in the filter. Such color light filters are widely used in the entertainment field, such as for example, in stage theaters, outdoor shows and other applications where relatively bright colored light is desired or required. By way of further example, a typical color light filter includes a transparent, or at least substantially transparent layer of plastic, such as for example a layer of substantially transparent thermoplastic material such as polycarbonate, and which layer of plastic has either or both of its outer surfaces suitably coating with a colored dye or which can have colored dye defused into either or both of its outer layer of surfaces. Alternatively, the colored dye can be dispersed throughout such layer of plastic material. Upon such dye being for example, red dye, the color light filter will be a red color light filter and will produce red light upon white light being transmitted to the red color light filter. The red color light filter will permit only red light to pass therethrough and the red color dye will block or absorb all other colors in the white light and prevent them from passing through the red color light filter. Accordingly, it will be understood that a layer of substantially transparent plastic material provided with dye as described above will be referred to hereinafter, and in the appended claims, as a layer of substantially transparent dye-colored plastic.

Generally and as is further known to the art, and by way of further example, such red color light filter upon absorbing the other light colors will become heated and can become sufficiently heated to reach the melting point of the layer of thermoplastic material, causing the color light filter to be destroyed. Further, as is known, as the colored light filter becomes increasingly heated the layer of thermoplastic material, will experience heat induced plastic flow characteristic which can distort the shape of the filter thereby distorting the colored light produced by the color light filter and such heat induced plastic flow characteristic can ultimately cause the filter to be destroyed.

More specifically, a typical prior art color light filter 10 and its implementation are illustrated diagrammatically in FIG. 1. The prior art color light filter 10 may be a layer of substantially transparent dye-colored plastic and is mounted in a suitable holder (not shown) in front of a white light source 12. It will be assumed that the layer of substantially transparent dye-colored plastic 10 has been colored with red dye as described above and is therefore a red color light filter. The white light source 12, as it known, typically includes at least a portion of the colors of the light in the visible spectrum from violet, through blue, through green, through yellow-orange to red. Some white lights sources, as is further known, also produce at least some ultraviolet light and of course, upon such white light source becoming heated, the white light source radiates and produces at least some infrared light. Referring further to FIG. 1, upon the white light indicated by general numerical designation 14 passing through the red color light filter 10, the filter will allow red color light indicated by general numerical designation 16 to pass therethrough but the red dye provided in the red color light filter 10 will absorb and block all of the other colors of light in the visible light spectrum contained in the white light 14 from passing through the red color light filter. Such absorption of light, as is known in the art and noted above, by the red dye in the red color light filter 10 will cause the filter to become heated and can become sufficiently heated to cause the red color light filter 10 to degrade, lose its strength or structural integrity and fade, or experience the above-noted heat induced plastic flow characteristic. These heat conditions can ultimately cause the color light filter to not only degrade, but be destroyed and have an unwantedly short useful life. Further, as is known in the above-noted theater application, the color light filter 10 may be located in a relatively inaccessible location in the theater which prevents the color light filter, upon deteriorating or failing as noted above, from being readily replaced such as during a theater production or performance.

Accordingly, there is need in the art for a new and improved color light filter which overcomes the above-noted heat problems and which has an increased useful life.

This invention further relates to an article of manufacture which may include a layer of substantially transparent dye-colored plastic having one surface coated with a layer of pressure-sensitive adhesive. The layer of adhesive may be covered with a suitable removable release liner or sheet. The pressure-sensitive adhesive may be used to adhere layer of substantially transparent dye-colored plastic to a substantially transparent layer of material such as a substantially transparent layer of glass which will convey away at least a portion of the heat from the layer of plastic upon the plastic becoming heated as described above in use as a color light filter.

### SUMMARY OF THE INVENTION

A color light filter including a layer of substantially transparent dye-colored plastic laminated to a layer of substantially transparent glass. A manufacture including a layer of substantially transparent dye-colored plastic having one surface coated with a layer of substantially transparent adhesive which may be covered by a release liner or sheet.

### DESCRIPTION OF THE DRAWINGS

FIG. 1 is a diagrammatical illustration of a typical prior art color light filter and its implementation;

FIG. 2 is a diagrammatical illustration of a laminated color light filter embodying the present invention; and

FIG. 3 is a diagrammatical illustration of another embodiment of the present invention.

### DESCRIPTION OF THE PREFERRED EMBODIMENT

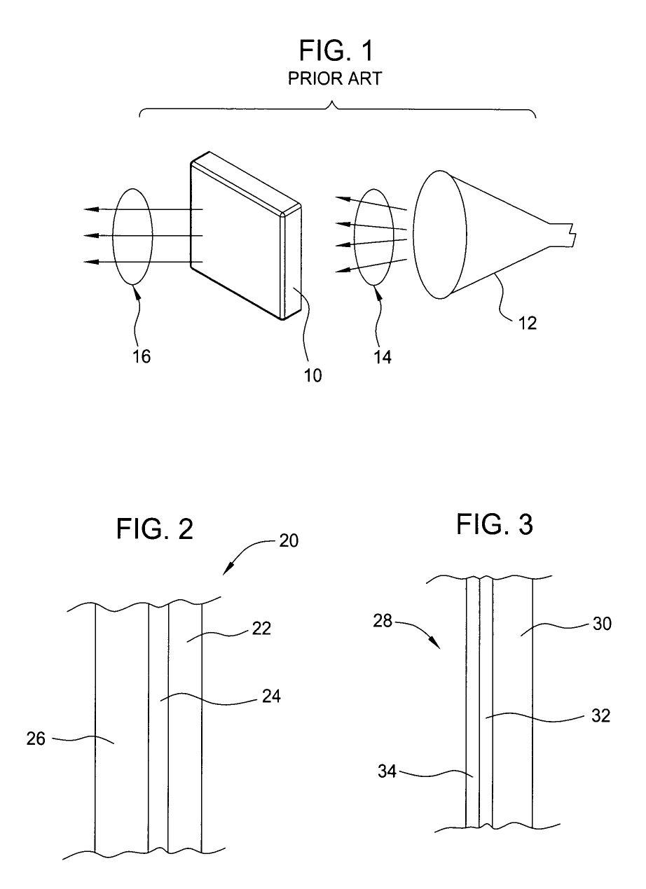

A diagrammatical illustration of a laminated color light filter embodying the present invention is shown in FIG. 2 and identified by general numerical designation 20. The laminated color light filter 20 includes a layer of substantially transparent dye-colored plastic 22 laminated by a layer of substantially transparent adhesive 24 to a layer of substantially transparent base material such as a layer of substantially transparent glass 26. In implementation, the laminated color light filter 20 of the present invention was oriented such that the layer of glass 26 would face the white light source such as the white light source 12 of FIG. 1.

In the preferred embodiment, the layer of glass 26 had a thermal conductivity a multiple of the thermal conductivity of the layer of plastic 22 and the layer of laminating adhesive 24 was sufficiently thick to laminate the layers of plastic and glass together and sufficiently thin to provide heat transfer from the plastic to the glass upon the plastic being heated as noted above. It has been discovered that such difference in thermal conductivity and such adhesive causes the heat produced in the plastic 22 to be substantially transferred to the glass 26 which glass dissipates or conducts away a substantial portion of the heat thereby increasing the useful life of the laminated color filter 20 of the present invention.

In one embodiment of the present invention, the layer of substantially transparent dye-colored plastic 22 was a layer of substantially transparent red dye-colored polycarbonate, the substantially transparent adhesive 24 was a pressure sensitive adhesive available from the Sony Corporation, Mount Pleasant, Pa., and sold under the trade name SK6300, and the layer of substantially transparent glass 26 was a layer of substantially transparent Pyrex. Pyrex is trademark for glass and is owned by the Corning Corporation, Corning, N.Y. The layer of substantially transparent red dye polycarbonate 22 was approximately 0.003″ in thickness, the layer of substantially transparent adhesive 24 was approximately 0.0002″ in thickness and the layer of substantially transparent Pyrex 26 was approximately 0.125″ in thickness. The layer of adhesive 24 was placed between the layers of plastic 22 and glass 26 and pressure of about 20 pounds per linear inch was applied for lamination. Pyrex has a thermal conductivity at 20 degrees C. of about 0.93 W/mk whereas polycarbonate has a thermal conductivity of about 0.202 W/mk, thus the thermal conductivity of the Pyrex is about 4.5 times the thermal conductivity of the polycarbonate.

Alternative to the components identified above for the elements comprising the laminated color light filter 20 in the preferred embodiment, the layer of substantially transparent dye-colored plastic 22 may be a layer of substantially transparent dye-colored polyester, acrylic, polypropylene, and the like. The substantially transparent layer of glass 26 may be a substantially transparent layer of quartz glass such as that available from Quartz Scientific, Inc., Fairport Harbor, Ohio, or a suitable substantially transparent temper glass. Further, alternatively, the substantially transparent layer adhesive 24 may be GP3 water based pressure-sensitive adhesive from Air Products Corp., Allentown, Pa., or other suitable substantially transparent pressure-sensitive adhesives. Still further alternatively, the substantially transparent layer of adhesive 24 may be other commercially available substantially transparent water based adhesive or a combination of water based and pressure sensitive adhesive.

It has been discovered that a laminated color light filter 20 including the layer of substantially transparent dye-colored plastic material 22 has a useful life of from four to five times the life of a color light filter including only the same layer of substantially transparent dye-colored plastic 22.

A further embodiment of the present invention is illustrated diagrammatically in FIG. 3 and indicated by the general numerical designation 28. This ultimate embodiment 28 is a separate article of manufacture and includes a layer of substantially transparent dye-colored plastic 30, of the types noted above, and a layer of substantially transparent pressure-sensitive adhesive 22 which may be any of the types noted above. The article of manufacture 28 may further include a suitable release liner or sheet 34 for preventing the adhesive 32 from being unwantedly adhered to an unintended surface or object. The embodiment 28 of FIG. 3 may be sold as a separate item of commerce and upon receipt the customer may remove the release liner or sheet 34 and use the layer of adhesive 32 to adhere the layer of substantially transparent dye-colored plastic 30 to a suitable layer of substantially transparent glass, of the types noted above, to thereby provide the laminated color light filter embodiment 20 of FIG. 2.

The laminated color light filter of the present invention has many advantages over colored light filters of the prior art. For example, generally, the cost of plastic is much less than the cost of glass. Accordingly, it is less expensive for a manufacturer and supplier of color light filters to maintain an inventory of plastic color light filters in many different colors and many different shades of colors. To the contrary, due to the difference in cost, it is relatively expensive for a manufacturer and supplier of color light filters to maintain a large inventory of glass color light filters in many different colors and many different shades of colors. With the laminated color light filter of the present invention, the manufacturer or supplier of color light filters need only maintain a large supply of relatively inexpensive plastic color light filters in many different colors and shades of colors and only maintain an inventory of substantially transparent glass to which the plastic color light filters may be laminated, thereby providing a large inventory of laminated color light filters embodying the present invention in many different colors and in many different shades of colors.

Another advantage of the laminated color light filter of the present invention is that upon such filter, for example, being dropped or broken, or falling from a relatively large height in a theater, the glass by being laminated through the adhesive to the layer of plastic will not shatter and be broadcast about potentially causing damage or injury to a person. Whereas, upon a glass color light filter being dropped, or falling from a height in a theater, the glass can shatter and broadcast glass shards about potentially causing damage and injury to people.

It will be understood that many variations and modifications may be made in the present invention without departing from the spirit and scope thereof.

1. A laminated color light filter, comprising a layer of substantially transparent dye-colored plastic laminated to a layer of substantially transparent glass.

2. A laminated color light filter, comprising:
a layer of substantially transparent dye-colored plastic;
a layer of substantially transparent glass; and
a layer of substantially transparent adhesive intermediate said layers and laminating said layers together.

3. A laminated color light filter, comprising:
a layer of substantially transparent dye-colored plastic having a first thermal conductivity;
a layer of substantially transparent base material having a second thermal conductivity greater than said first thermal conductivity; and
a layer of substantially transparent adhesive intermediate said layer of substantially clear dye-colored plastic and said layer of substantially transparent base material, said adhesive laminating said layers together and providing heat transfer from said layer of substantially transparent dye-colored plastic to said layer of substantially transparent base material.

4. The laminated color light filter according to claim 3 wherein said layer of substantially transparent dye-colored plastic material is a layer of substantially transparent dye-colored thermoplastic material.

5. The laminated color light filter according to claim 4 wherein said layer of substantially transparent dye-colored thermoplastic material is a layer of substantially transparent dye-colored polycarbonate.

6. The laminated color light filter according to claim 3 wherein said layer of substantially transparent base material is a layer of substantially transparent glass.

7. The laminated color light filter according to claim 6 wherein said layer of substantially transparent glass is a layer of substantially transparent Pyrex.

8. The laminated color light filter according to claim 3 wherein said layer of substantially transparent glass is a layer of substantially transparent quartz glass.

9. The laminated color light filter according to claim 3 wherein said layer of substantially transparent base material has a second thermal conductivity about 4 times the first thermal conductivity of said layer of substantially transparent dye-colored plastic.

10. The laminated color light filter according to claim 3 wherein said layer of substantially transparent adhesive is sufficiently thick to laminate said layer of substantially transparent dye-colored plastic to said layer of substantially transparent base material and is sufficiently thin to transfer heat from said layer of substantially transparent dye-colored plastic to said layer of substantially transparent base material.

11. The laminated color light filter according to claim 10 wherein said layer of substantially transparent adhesive has a thickness of about 0.0002 inch.

12. The laminated color light filter according to claim 3 wherein said layer of substantially transparent dye-colored plastic has a thickness of about 0.003 inch.

13. The laminated color light filter according to claim 3 wherein said layer of substantially transparent base material has a thickness of about 0.125 inch.

14. A manufacture comprising:
a layer of substantially transparent colored plastic for providing at least a portion of a color light filter; and
a layer of substantially transparent pressure sensitive adhesive adhered to one surface of said layer of plastic and for adhering said layer of plastic to a substantially transparent layer of glass for conveying away at least a portion of the heat upon said layer of plastic becoming heated while functioning as at least a portion of a color light filter.

15. The manufacture according to claim 14 wherein said manufacture further comprises a layer of release material adhered to said layer of adhesive.
